(19) United States
(12) Patent Application Publication
(10) Pub. No.: US 2021/0356706 A1
(43) Pub. Date: Nov. 18, 2021

(54) EXTERNAL LENS FOR MOBILE TERMINAL

(71) Applicant: GUANGDONG SIRUI OPTICAL CO., LTD., ZHONGSHAN (CN)

(72) Inventors: JIE LI, ZHONGSHAN (CN); WEI WU, ZHONGSHAN (CN)

(73) Assignee: GUANGDONG SIRUI OPTICAL CO., LTD., ZHONGSHAN (CN)

(21) Appl. No.: 16/477,183

(22) PCT Filed: Jan. 24, 2019
(86) PCT No.: PCT/CN2019/072901

§ 371 Date: Jul. 10, 2019

(30) Foreign Application Priority Data
Dec. 26, 2018 (CN) 201811617578.6

(51) Int. Cl. G02B 13/00; G02B 3/06; H04M 1/02

(52) U.S. Cl. CPC G02B 13/0035; H04M 1/0264; G02B 3/06; G02B 13/006

(57) ABSTRACT

An external lens for a mobile terminal includes a first lens group and a second lens group composed of cylindrical lenses arranged from an object side to an image side, the first lens group of light in the X direction The power of the second lens group in the X direction is greater than zero; the power in the Y direction of the external lens is zero. In this way, by using the unique optical characteristics of the cylindrical mirror, the horizontal field of view of the camera of the mobile terminal may be increased and the vertical field of view angle is not changed.

### TECHNICAL FIELD

Aspects of aspects of the invention relate to mobile terminal photographic accessories. Specifically, aspects of aspects of the invention relate to an external lens for a mobile terminal.

### BACKGROUND

With the development of mobile internet technology, mobile phones have become one of the daily necessities. In recent years, the camera capabilities of mobile terminals such as mobile phones continue to improve, and the functional quality has become more and more powerful. Mobile phones are gradually replacing ordinary digital cameras as the preferred camera of choice for the public. With the increasing power of mobile video capturing, more and more users are beginning to try to use mobile phones to shoot professional short films, micro-movies and other wide-format ratios (such as 1.85:1, 2.39:1).

However, the current display ratio of mobile terminals such as mobile phones and tablet computers is 16:9, and the ratio of the video or short film obtained by direct shooting is also 16:9, and it is impossible to directly obtain video works with a wide format ratio. In order to produce a wide-frame-to-video work, the prior art usually uses a software-cut frame to convert the frame. However, the cropped video file has a small horizontal field of view and causes a reduction in the content of the vertical field of view and a reduction in resolution. Problems such as impaired image quality also affect video quality.

Therefore, ensuring video quality and field of view when shooting a wide format video than a mobile terminal such as a mobile phone has become a technical problem that needs to be solved.

### SUMMARY

Therefore, the technical problem to be solved by aspects of aspects of the invention includes providing an external lens for the mobile terminal to overcome the prior art, when using a mobile terminal such as a mobile phone to shoot a wide format, that the horizontal field of view angle is smaller, the vertical field angle content is reduced, the resolution is reduced, and the image quality is affected.

An external lens for a mobile terminal provided by aspects of aspects of the invention may include a first lens group and a second lens group composed of a cylindrical lens disposed from an object side to an image side, and the first lens group is in the X direction. The degree of power in the X direction of the second lens group is greater than zero; the power in the Y direction of the external lens is zero.

In one embodiment, the cylindrical lens may be disposed as two, which are a first lens and a second lens; the first lens group includes the first lens, and the second lens group includes the second lens.

In another embodiment, the first lens may be a negative-concave flat-concave cylindrical lens; and/or the second lens is a positive-powered meniscus cylindrical lens.

In a further embodiment, the cylindrical lens may be set to three, which are a first lens, a second lens and a third lens; the first lens group comprises the first lens, and the second lens group comprises a glued device. The second lens and the third lens are described.

In an alternative embodiment, the first lens group and the second lens group may satisfy the following conditions:

−0.85<f₁/f₂<−0.70,

where f1 is the focal length of the first lens group in the X direction, and f2 is the focal length of the second lens group in the X direction.

In yet another embodiment, the first lens group may be made of a low refractive index and high Abbe number material; and the second lens group may be made of a high refractive index and low Abbe number material.

In yet another embodiment, the first lens set may satisfy the following conditions:

1.48<Nd<1.74, 52<Vd<72;

Where Nd is the refractive index of d light, and Vd is the Abbe value; and/or,

the second lens set may satisfy the following conditions:

1.7<Nd<1.95, 16<Vd<30;

Where Nd is the refractive index of d light, and Vd is the Abbe value.

In another aspect, the cylindrical lens has a square axisymmetric structure, and the maximum cylindrical lens length of the external lens is <26 mm, and the width is <24 mm.

In yet another aspect, the external lens comprises a cylindrical lens body, and the cylindrical lens is disposed on the lens body, the lens body has a TTL<17.0 mm and a maximum outer diameter of <38 mm.

In an alternative aspect, the mobile terminal is a mobile phone, and the external lens is used in conjunction with a rear camera of the mobile phone.

In a further embodiment, the mounting structure may be mounted on the mobile phone and the lens body detachably mounted on the mounting structure. The at least two cylindrical lenses may be disposed on the lens body.

Moreover, the technical solutions of aspects of the invention include the following advantages:

An external lens for a mobile terminal provided by aspects of aspects of the invention includes a first lens group and a second lens group composed of cylindrical lenses arranged from an object side to an image side, the first lens group being in the X direction with the power is less than zero, the power of the second lens group in the X direction is greater than zero; and the power of the external lens in the Y direction is zero. So designed, by using the unique optical characteristics of the cylindrical mirror, the horizontal field of view of the camera of the mobile terminal may be increased and the vertical field of view angle may not be changed. The first lens group may be used for adjusting the light entering the external lens, the main function may be the angle of the light entering the horizontal direction is increased. The second lens group may be used for adjusting the light, so that the light entering the camera of the mobile terminal after being emitted from the external lens is substantially the same as the light entering the mobile terminal itself; for example, no vignetting, clarity, and the degree is consistent with the mobile terminal itself. Through professional post-production software (such as FILMIC PRO), users may realize the function of shooting wide-format than movie video in mobile terminal; and the users may not need to crop or crop less content, and aspects of aspects of the invention may ensure the image quality of video while shooting wide format than video.

The external lens for a mobile terminal provided by aspects of aspects of the invention may include the first lens and the second lens that may satisfy the following condition: −0.85<f1/f2<−0.70, where f1 is the focal length of the first lens X direction, and f2 is the first Two lens X direction focal length. By adopting the first lens and the second lens of the above focal length ratio, the horizontal field angle of the camera of the mobile terminal may be increased by about 33% and the vertical field of view angle is not changed; when the external lens is used with a mobile terminal with a shooting ratio of 16:9 through the professional post-production software (such as FILMIC PRO), it may realize the function of the movie video with the frame ratio of 2.39:1, and it does not need to be cropped to ensure the horizontal field of view angle and image quality of the video.

### BRIEF DESCRIPTION OF THE DRAWINGS

In order to more clearly illustrate the specific embodiments of aspects of the invention or the technical solutions in the prior art, the drawings to be used in the specific embodiments or the description of the prior art are briefly described below, and obviously, the attached in the following description and the drawings illustrate some embodiments of aspects of the invention, and those skilled in the art may obtain other drawings based on these drawings without any undue experimentation.

FIG. 1 is a schematic diagram of an optical structure of an external lens for a mobile terminal according to a first embodiment of aspects of the invention;

FIG. 2 is a vertical axis chromatic aberration diagram of an external lens embodiment for a mobile terminal according to aspects of aspects of the invention;

FIG. 3 is a front view of a vertical direction of an embodiment of an external lens for a mobile terminal according to aspects of aspects of the invention;

FIG. 4 is a horizontal alignment diagram of an external lens embodiment of a mobile terminal according to one embodiment of the aspects of aspects of the invention;

FIG. 5 is a modulation transfer function (MTF) graph of a vertical direction of an external lens embodiment for a mobile terminal according to aspects of aspects of the invention;

FIG. 6 is an MTF graph of a horizontal direction of an external lens embodiment for a mobile terminal according to aspects of aspects of the invention.

### REFERENCE NUMBER LISTING

1—first lens;
2—second lens;
a: Airy disc;
b: 0.4861 μm;
c: 0.5460 μm;
d: 0.4360 μm;
e: 0.5876 μm;
f: 0.6563 μm.

### DETAILED DESCRIPTION

The technical solutions of aspects of the invention may be clearly and completely described in the following with reference to the accompanying drawings. It is intended that the described embodiments are a part of the embodiments of aspects of the invention, and not all of the embodiments. All other embodiments obtained by those skilled in the art based on the embodiments of aspects of the invention without creative efforts are within the scope of aspects of the invention.

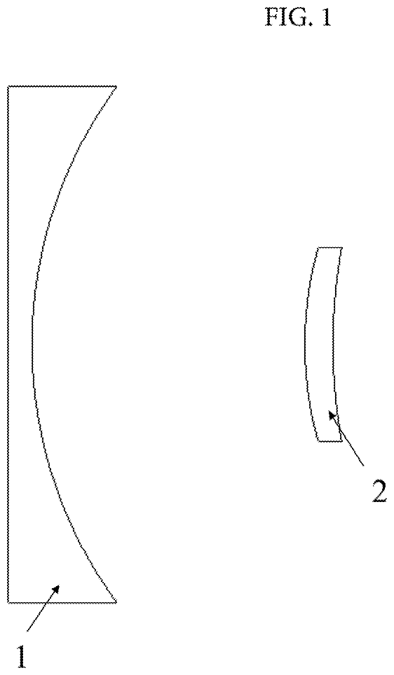

Referring now to FIG. 1, FIG. 1 shows an embodiment of an external lens for a mobile terminal provided by aspects of aspects of the invention. As shown in FIG. 1, the external lens uses two cylindrical lenses (not in scale), and adopts two sets of two sets of optical designs, including a first lens group and a second lens group from the object side to the image side. The first lens group includes a first lens 1 and the second lens group includes a second lens 2. The first lens 1 is a flat concave cylindrical mirror of negative power. The second lens 2 is a meniscus cylindrical mirror of positive power. The Y-direction power of the first lens group and the second lens group are both zero. The focal length in the X direction satisfies the following relationship: −0.85<f₁/f₂<−0.70,

where f1 is the focal length of the first lens group in the X direction, and f2 is the focal length of the second lens group in the X direction.

In this embodiment, f1 is the focal length of the first lens X (sagittal) direction, and f2 is the focal length of the second lens X (sagittal) direction.

The external lens for the mobile terminal provided by aspects of the invention is used with a mobile terminal camera with a shooting ratio of 16:9. By utilizing the unique optical characteristics of the cylindrical mirror, aspects of the invention may increase the angle of view of the horizontal field of view by about 33% while the vertical field of view angle is constant. The first lens group is used for adjusting the light entering the external lens, and the main function may increase the angle of the light entering in the horizontal direction, that is, the horizontal field angle is increased by about 33% in the embodiment. The second lens group is used to adjust the light. The light entering the camera of the mobile terminal after being shot from the external lens is substantially the same as the incident light when the mobile terminal itself photographs, for example, no vignetting, sharpness and consistency of the mobile terminal itself.

However, the mobile terminal still uses the 16:9 ratio storage after the horizontal field of view compression, so it is necessary to use the post-processing software, such as FILMIC PRO and other professional post-software to restore the compressed content and correct the distortion, so that the user can use the self-shooting ratio of 16:9. The mobile terminal captures a wide-screen movie video with the external lens of aspects of the invention at a frame ratio of 2.39:1, and does not require cropping, while ensuring the image quality of the video.

The horizontal field of view of the external lens for the mobile terminal provided by aspects of the invention is not limited to 33%. When less than 33%, the compressed content may be recovered by the later software, and the deformation is corrected, and the width of 2.39:1 is cut. When comparing with the prior art, wide-screen movie video taken by aspects of the invention may increase the horizontal field of view angle, reduce the amount of vertical field of view cropping, reduce cropping loss content, while ensuring the image quality of the video.

The external lens for the mobile terminal provided by aspects of the invention is not limited to shooting a video having a frame ratio of 2.39:1, and the horizontal field of view angle may be adjusted by adjusting the focal length relationship of the first lens group and the second lens group in the X direction. As such, aspects of the invention may be modified to suit different application scenarios. For example, an external lens can increase the horizontal field of view angle by about 5%, allowing a user to shoot a wide-screen movie video with a frame ratio of 1.85:1 using a 16:9 mobile terminal, without the need for cropping, while ensuring video quality of the image.

The external lens for the mobile terminal provided by aspects of the invention is not limited to use with a mobile terminal camera with a shooting ratio of 16:9. When using the mobile terminal camera with other shooting ratios, the same principle may still be used by expanding the horizontal field of view angle. As such, the user may achieve wide format ratio video shooting without the need to crop or crop less content, and to ensure the horizontal field of view angle and image quality of the video.

The first lens 1 adopts a flat concave cylindrical mirror, and the second lens 2 adopts a meniscus cylindrical lens to reduce the structural size on the basis of satisfying optical properties such as optical power, definition, color reproduction degree, etc., to ensure the overall external lens portability.

However, the first lens 1 is not limited to a flat concave cylindrical mirror, but may be other types of negative power cylindrical lenses. The second lens 2 is not limited to the meniscus-shaped cylindrical lens in the embodiment, and may be a biconvex or plano-convex cylindrical lens of positive refractive power.

The first lens 1 in the first lens group is made of a low refractive index, high Abbe number material. The second lens 2 in the second lens group is made of a high refractive index, low Abbe number material. In general, the larger the refractive index of the medium, the stronger the dispersion, and the smaller the Abbe number; conversely, the smaller the refractive index of the medium, the less the dispersion is, and the larger the Abbe number. Generally, the Abbe number Vd>50 may be considered a high Abbe number material, and the Vd<40 may be considered a low Abbe number material. Take Chengdu Bright Materials as an example: H-QK3L, H-FK61, H-LaF1, etc. are common high Abbe number low refractive index materials, H-ZLaF4la, H-ZF88, etc. are typical low Abbe number high refractive index. material.

In the external lens for a mobile terminal provided by aspects of the invention, the d-light refractive index Nd and the Abbe number Vd of the first lens 1 satisfy the following conditions: 1.48<Nd<1.74, 52<Vd<72. The d-light refractive index Nd and the Abbe number Vd of the second lens 2 satisfy the following conditions: 1.7<Nd<1.95, 16<Vd<30. The design ensures that the color reproduction degree of the video taken by the mobile terminal after the external lens provided by aspects of the invention is externally connected.

In the external lens for the mobile terminal provided by aspects of the invention, the first lens 1 and the second lens 2 are cylindrical lenses, the cylindrical lens is a square axisymmetric lens, and the front projection perpendicular to the direction of action of the lens is square, this embodiment The medium-sized cylindrical lens has a length of <26 mm and a width of <24 mm to ensure the size of the final product, thus ensuring the portability of the external lens.

The first lens 1 and the second lens 2 are mounted on the cylindrical housing. The cylindrical housing, the first lens 1 and the second lens 2 are assembled into a lens body, and the TTL (Total Track Length) of the lens body. Less than 17 mm, the maximum outer diameter is less than 38 mm, so that in order to ensure the compactness and portability of the external lens, it is convenient for the user to carry around.

The external lens for a mobile terminal provided by aspects of the invention is not limited to the optical structures of the two cylindrical lenses of the first lens 1 and the second lens 2, and two or more cylindrical lenses may be employed. For example, three sets of two sets of optical designs may be employed, including first and second lens sets from the object side to the image side. The first lens set includes a first lens and the second lens set includes a glued second lens and a third lens. The first lens, the second lens and the third lens are both cylindrical lenses, and the power in the Y direction of the external lens is zero, the power in the X direction of the first lens group is less than zero, and the X direction of the second lens group is The power is greater than zero. Others are the same as the above embodiment. The external lens provided by aspects of the invention can also adopt a combination of more lenses, which meets the design requirements of the first lens group and the second lens group in the above embodiments, but is comprehensively measured based on factors such as weight, volume, cost, and the like. Two cylindrical lenses are a more preferred embodiment.

In this embodiment, the mobile terminal is a mobile phone, and the external lens is used in conjunction with the rear camera of the mobile phone. The external lens includes a mounting structure mounted on the mobile phone, and the lens body is detachably mounted on the mounting structure. In this embodiment, the mounting structure is a mobile phone case that is adapted to the mobile phone, and the lens body is mounted on the mobile phone case through a threaded structure. Obviously, the lens body may be detachably engaged with the mobile phone case by means of a linear slider, a rotary snap, and a magnetic attraction. The mounting structure can also be a housing structure that mates with or wraps the end of the handset, or a clip that is clamped to the handset.

The optical design and size design of the external lens for the mobile terminal provided by the invention not only optimizes the size of the CMOS chip of the Apple® mobile phone, but also optimizes and controls the mainstream Android® mobile phones (such as Huawei®, Samsung®, Xiaomi®, OPPO®, VIVO®, etc.). Therefore, it may be applied to a variety of mobile phones to ensure the compatibility of the external lens.

Obviously, the external lens may be used for the front camera of the mobile phone, and can also be used for mobile terminals such as tablet computers and sports cameras.

The invention provides a specific optical design example of an external lens for a mobile terminal, and the specific parameters are as follows:

| | Surface | X Radius | | Thickness | |
|---|---|---|---|---|---|
| Lens | Type | (mm) | Y Radius | (mm) | Material |
| First | Cylindrical | Infinite | Infinite | 1.300 | H-QK3L |
| lens | Cylindrical | 20.250 | Infinite | 12.720 | |
| Second | Cylindrical | 16.510 | Infinite | 1.500 | H-ZF52A |
| Lens | Cylindrical | 24.920 | Infinite | | |

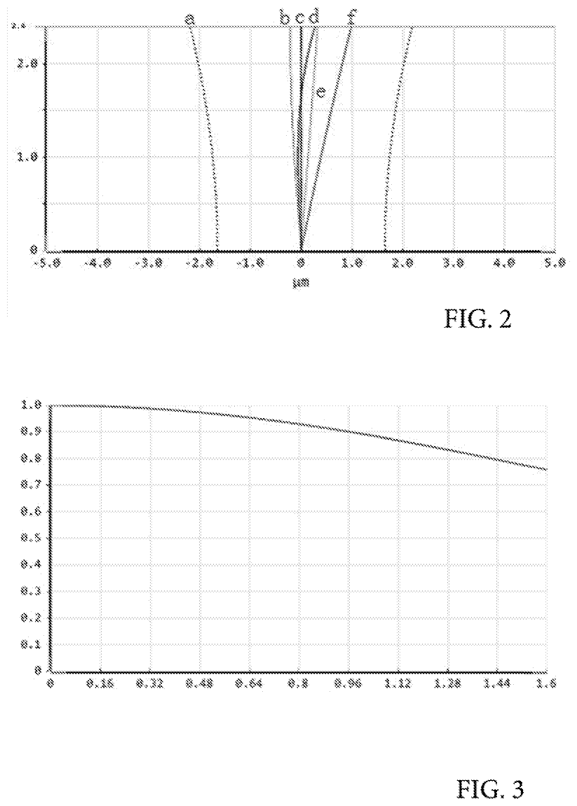

The above embodiment was optically tested, and the test results are shown in FIGS. 2 to 6.

FIG. 2 is a vertical axis chromatic aberration diagram. It may be seen from the figure that the chromatic aberration of the vertical lens of the external lens is ensured by strict chromatic aberration correction <1.5 μm, thereby ensuring the color reproduction degree of the video captured by the mobile phone after the external lens of aspects of the invention is externally connected.

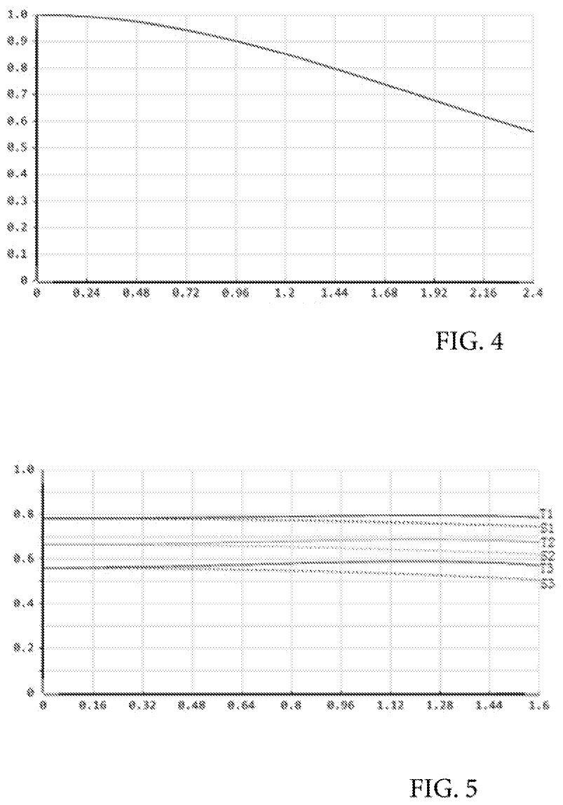

FIGS. 3 and 4 are phase contrast graphs. It may be seen from the figure that by optimizing the optical structure parameters, the relative optical illuminance of the outermost edge of the external lens is >58%, and the relative optical illuminance of the most edge of the vertical direction is >75%. Therefore, the brightness balance of the video captured by the mobile phone after the external lens provided by the invention is externally connected is ensured.

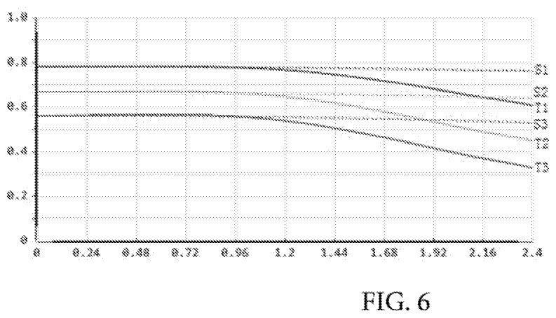

FIG. 5 and FIG. 6 show the modulation transfer function (MTF) image quality diagram. It may be seen from the horizontal and vertical MTF resolution simulation diagram that the external lens is excellently solved by strictly correcting various optical aberrations, thus ensuring the external connection of the mobile phone. The clarity of the video captured by the mobile phone after the external lens provided by the invention is provided.

It may be seen from the above test that after the external lens provided by the invention is externally connected by the mobile phone, the optical imaging quality is extremely high. In the expansion of the phone shooting ratio, change the optical characteristics of the phone while maintaining the clarity and color reproduction of the video does not decline.

It is apparent that the above-described embodiments are merely illustrative of the examples, and are not intended to limit the embodiments. Other variations or modifications of the various forms may be made by those skilled in the art in light of the above description. There is no need and no way to exhaust all of the implementations. Obvious changes or variations resulting therefrom are still within the scope of aspects of the invention.

The following claims will replace all prior versions of the claims in this application:

1: An external lens for a mobile terminal, comprising:
a first lens group and a second lens group consisting of cylindrical lenses arranged from an object side to an image side, the first lens group being in the X direction with a power less than zero, a power of the second lens group in the X direction is greater than zero; and a power of the external lens in the Y direction is zero.

2: The external lens according to claim 1, wherein the cylindrical lens is provided in two, which are a first lens (1) and a second lens (2); the first lens group includes a first lens (1), and the second lens group comprising the second lens (2).

3: The external lens according to claim 2, wherein the first lens (1) is a concave-convex cylindrical lens of negative power; and/or the second lens (2) is a positive light a meniscus cylindrical lens.

4: The external lens according to claim 1, wherein the cylindrical lens is provided as three, which are a first lens, a second lens and a third lens; and the first lens group includes the first lens a lens, the second lens set comprising the second lens and the third lens glued together.

5: The external lens according to claim 1, wherein the first lens group and the second lens group satisfy the following conditions: −0.85<f1/f2<−0.70, wherein f1 is the focal length of the first lens group in the X direction, and f2 is the focal length of the second lens group in the X direction.

6: The external lens according to claim 1, wherein the first lens group is made of a low refractive index and a high Abbe number material; and the second lens group is made of a high refractive index, Rate, low Abbe number material.

7: The external lens according to claim 1, wherein the first lens group satisfies the following conditions:
1.48<Nd<1.74, 52<Vd<72;
Nd is the refractive index of d light, and Vd is the Abbe number; and/or,
the second lens set satisfies the following conditions:
1.7<Nd<1.95, 16<Vd<30;
Nd is the refractive index of d light, and Vd is the Abbe number.

8: The external lens according to claim 1, characterized in that the cylindrical lens has a square axisymmetric structure, and the maximum cylindrical lens length of the external lens is <26 mm and the width is <24 mm.

9: The external lens according to claim 8, wherein the external lens comprises a cylindrical lens body, the cylindrical lens is disposed on the lens body, and the lens body is TTL<17.0 mm, which is the largest The diameter is <38 mm.

10: The external lens according to claim 1, wherein the mobile terminal is a mobile phone, and the external lens is used in conjunction with a rear camera of the mobile phone.

11: The external lens according to claim 10, comprising: a mounting structure mounted on the mobile phone; and a lens body detachably mounted to the mounting structure; the at least two cylindrical lenses are disposed on the lens body.
